(19) United States
(12) Patent Application Publication
(10) Pub. No.: US 2009/0225642 A1
(43) Pub. Date: Sep. 10, 2009

(54) SWITCHABLE OPTICAL ELEMENT

(75) Inventors: Teunis Willem Tukker, Eindhoven (NL); Bernardus Hendrikus Wilhelmus Hendriks, Eindhoven (NL); Stein Kuiper, Eindhoven (NL); Joris Jan Vrehen, Eindhoven (NL); Petrus Theodorus Jutte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,857

(22) PCT Filed: Nov. 21, 2005
(86) PCT No.: PCT/IB2005/053828

§ 371 Date: May 22, 2007

(30) Foreign Application Priority Data
Nov. 25, 2004 (EP) 04106089.8

(51) Int. Cl. G11B 7/135; G02B 3/14

(52) U.S. Cl. 369/112.23; 359/666; G9B/7.112

(57) ABSTRACT

A switchable optical element having an optical path (OP) for a radiation beam and having a first state and a second state, the element comprising: a first fluid (12) and a second, different, fluid (14) which are immiscible and which are separated from each other by a fluid meniscus (16); a first, transparent, wall part and a second, transparent, wall part spaced from each other along the optical path; and a fluid switching system which is arranged to apply forces to the first and/or the second fluid in order to switch the element between the first and the second state. The first wall part includes a non-planar wavefront modifier (28), and wherein the fluid switching system is arranged to apply the forces so that when the element is in the first state, the first wall part is covered by the first fluid (12); and when the element is in the second state, the first wall part is covered by the second fluid (14). The switchable optical element is characterised in that the fluid switching system is arranged to switch between the first state and the second state such that when the element is in the first state the second wall part is covered by the second fluid, and when the element is in the second state the second wall part is covered by the first fluid. When the element is in both the first state and the second state, at least part of the fluid meniscus (16) is located on the optical path.

### FIELD OF THE INVENTION

The present invention relates to a switchable optical element, particularly, but not exclusively, suitable for use in an optical scanning device for scanning an information layer of an optical record carrier; and to an optical scanning device including such an element.

### BACKGROUND OF THE INVENTION

Switchable optical elements which have different states for introducing different wavefront modifications into radiation beams are known. Switching the optical element between different states changes the wavefront modification introduced into a radiation beam when passing through the optical element.

International patent application WO 04/027490 describes a switchable optical element which has two different states. The element has a chamber, which is filled with one fluid in one state and is filled with a different fluid in the other state. A wavefront modifier modifies a wavefront of a radiation beam passing through the chamber. The wavefront modification of the radiation beam depends upon both the state, which the optical element is switched into, and a wavelength of the radiation beam.

The switchable optical element disclosed in WO 04/027490 is included within an optical scanning device for scanning the information layer of different formats of optical record carriers, for example a Compact Disc (CD), a conventional Digital Versatile Disc (DVD) and a Blu-Ray™ Disc (BD). The wavelength of the radiation beam used to scan the record carriers is different for the different formats. Each format has a cover layer lying between the information layer and an exterior of the record carrier, which has a different thickness. By switching between different states of the switchable optical element these different thicknesses are accommodated so that the different formats of record carrier can be scanned correctly.

The variety of wavefront modifications which can be introduced into a radiation beam by the switchable optical element is relatively limited by the element's construction. Furthermore, the switchable optical element does not provide a functionality, which allows an optical scanning device to scan optical record carriers having multiple information layers. The element is relatively bulky as the element has a conduit, lying outside of an optically operative area, which is filled with one fluid whilst the other fluid fills the chamber.

International patent application WO 03/069380 discloses a variable focus lens having a meniscus, which separates two fluids. The fluid meniscus has a curvature, which introduces a focus into a radiation beam passing through the meniscus. Application of a voltage to electrodes of the lens varies a curvature of the meniscus in order to vary the focus of the radiation beam. An optical scanning device is disclosed which includes the variable focus lens and which can scan different information layers of a record carrier by varying the focus of the lens.

International patent application WO 04/051323 discloses apparatus for forming variable fluid meniscus configurations. The apparatus comprises a fluid meniscus, which separates two fluids. By applying different patterns of voltages to a configuration of electrodes surrounding the meniscus, different configurations of the meniscus can be obtained. In one embodiment, a radiation beam passes through a transparent electrode and is reflected by the fluid meniscus, which has a planar configuration, through a further transparent wall of the apparatus. In a different embodiment, the pattern of voltages applied to the electrodes causes the meniscus to adopt an asymmetric curvature, which introduces an applied focus into a radiation beam passing through the meniscus. Variation of the voltages causes the curvature of the meniscus to change.

### SUMMARY OF THE INVENTION

It is an object of the present invention to provide a switchable optical element, which introduces different wavefront modifications into a radiation beam in a relatively efficient manner.

In accordance with one aspect of the present invention, there is provided a switchable optical element having an optical path for a radiation beam and having a first state and a second state, said element comprising:

a) a first fluid and a second, different, fluid which are immiscible and which are separated from each other by a fluid meniscus;

b) a first, transparent, wall part and a second, transparent, wall part spaced from each other along the optical path; and

c) a fluid switching system which is arranged to apply forces to said first and/or said second fluid in order to switch said element between said first and said second state,

wherein the first wall part includes a non-planar wavefront modifier, and wherein the fluid switching system is arranged to apply said forces so that:

when the element is in the first state, said first wall part is covered by the first fluid; and when the element is in the second state, said first wall part is covered by the second fluid,

characterised in that the fluid switching system is arranged to switch between said first state and said second state such that when the element is in the first state said second wall part is covered by the second fluid, and when the element is in the second state said second wall part is covered by the first fluid, wherein when the element is in both the first state and the second state at least part of said fluid meniscus is located on the optical path.

When a radiation beam passes along the optical path the switchable optical element, when in the first state, introduces a desired wavefront modification into the radiation beam. By switching the element to the second state a different, desired, wavefront modification can be introduced into a radiation beam. The form of each introduced wavefront modification depends upon factors including: a wavelength of the radiation beam, a material of the first fluid and of the second fluid, a structure and a material of the non-planar wavefront modifier, and whether the first and the second wall parts are covered by the first or the second fluid. Each of these factors provides a degree of freedom to a designer designing the switchable optical element to introduce particular wavefront modifications into different radiation beams.

With the fluid meniscus being located on the optical path when the element is in the first state and the second state, the first fluid and the second fluid are both located on the optical path. Switching between the first and the second states causes the two fluids to change places within the element so that they cover different of the first and second wall parts. It is therefore possible to switch between different forms of introduced wavefront modifications. The fluid meniscus may at least partially contribute to the form of an introduced wavefront modification in dependence on a configuration of the meniscus and/or on the materials of the first and the second fluids. In this way a further degree of design freedom is provided.

As a result of these different degrees of design freedom, the switchable optical element of the present invention has a relatively high level of customisation so that a relatively large variety of different and desired wavefront modifications can be introduced into at least one radiation beam and the wavefront modification can be changed simply by switching the state of the element or by changing a characteristic of the radiation beam, such as a wavelength. This is advantageous as the element can be designed and constructed to meet a relatively wide range of criteria required by optical applications needing to introduce a wavefront modification into a radiation beam.

In accordance with a further preferred embodiment of the present invention, when the element is in at least one of the first and the second state, said fluid meniscus is capable of being arranged to focus a radiation beam travelling along the optical path.

With the fluid meniscus being capable of focusing a radiation beam travelling along the optical path, a wavefront modification can be introduced such that a radiation beam is focused as a spot onto a desired position. This allows the switchable optical element to be used in optical applications where it is desirable to focus a radiation beam onto a desired position.

Preferably, in accordance with an embodiment of the present invention, when said element is in at least one of the first and the second state, said fluid meniscus has a curvature which determines an amount of said focus and said element comprises a variable focus system capable of varying the curvature of the fluid meniscus.

Variation of the curvature of the fluid meniscus allows the focus of the radiation beam to be varied in a relatively efficient and controlled manner. This, consequently, allows the switchable optical element to be used in optical applications where it is desirable to vary the position, which a radiation beam is focused onto.

In a preferred embodiment of the present invention, said fluid switching system includes a first and a second switching electrode, wherein

said fluid switching system is arranged to apply a voltage to said first switching electrode in order to switch said element to said first state, and wherein

said fluid switching system is arranged to apply a voltage to said second switching electrode in order to switch said element to said second state.

Application of a voltage to different electrodes in order to switch the state of the element allows the switching to be performed in a relatively rapid and efficient manner. This minimises any delay between the introduction of one wavefront modification and the introduction of a different wavefront modification into a radiation beam.

In a further preferred embodiment of the present invention said optical element includes a further electrode, wherein

when switching between the first state and the second state, said fluid switching system is arranged to apply a voltage to said further electrode, and wherein

when varying the curvature of the fluid meniscus, said variable focus system is arranged to apply a voltage to said further electrode.

Application of a voltage to the further electrode when switching between the first and the second state changes the positions of the first and the second fluids within the element in a relatively rapid manner such that the switching of the element is relatively efficient.

Preferably, in an embodiment of the present invention said non-planar wavefront modifier includes at least one of: an aspherical lens; a phase structure having a periodic profile; and a phase structure having a non-periodic profile.

Selection of a specific structure of the non-planar wavefront modifier allows a desired wavefront modification to be introduced into a radiation beam travelling along the optical path. In the case where the wavefront modifier includes more than one different type of wavefront modifier, different forms of wavefront modifications can be introduced into radiation beams having different predetermined wavelengths.

In a preferred embodiment of the present invention, said first fluid has a first refractive index and said second fluid has a second, different, refractive index, wherein said non-planar wavefront modifier is formed of a material having a refractive index which is approximately the same as said second refractive index.

With the material of the non-planar wavefront modifier having the same refractive index as that of the second fluid, and when the element is in the second state with the second wall part covered by the first fluid, the wavefront modifier introduces a zero wavefront modification in a radiation beam passing along the optical path. In this way a functionality of the wavefront modifier, and therefore the introduction of a wavefront modification into the radiation beam, can be switched on and off by switching between the states of the switchable optical element.

According to a further aspect of the present invention, there is provided an optical scanning device for scanning a record carrier having an information layer, wherein said optical scanning device comprises:

a) a switchable optical element in accordance with the invention;

b) a radiation beam source system arranged to provide a radiation beam having a predetermined wavelength;

c) an objective lens system arranged to focus said provided radiation beam to a scanning spot on said information layer; and

d) a detection system arranged to detect the radiation beam after scanning of the information layer and to convert radiation of the detected radiation beam into electrical signals.

The switchable optical element included in the optical scanning device is adapted to introduce a wavefront modification into a radiation beam for scanning a record carrier in a relatively accurate manner. Furthermore, with suitable adaptation of the switchable optical element, the optical scanning device can scan optical record carriers of different formats and/or comprising a plurality of information layers in a relatively accurate manner.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically a cross section of a switchable optical element in a first state in accordance with an embodiment of the present invention.

FIG. 2 shows schematically a cross section of the switchable optical element, in accordance with an embodiment of the present invention.

FIG. 3 shows schematically a cross section of the switchable optical element in an intermediate state in accordance with an embodiment of the present invention.

FIG. 4 shows schematically a cross section of the switchable optical element in a second state in accordance with an embodiment of the present invention.

FIG. 5 shows schematically a cross section of a switchable optical element in a first state in accordance with a different embodiment of the present invention.

FIG. 6 shows schematically a cross section of the switchable optical element, in accordance with the different embodiment of the present invention.

FIG. 7 shows schematically a cross section of the switchable optical element in an intermediate state in accordance with the different embodiment of the present invention.

FIG. 8 shows schematically an optical scanning device in accordance with an embodiment of the present invention.

### DETAILED DESCRIPTION OF THE INVENTION

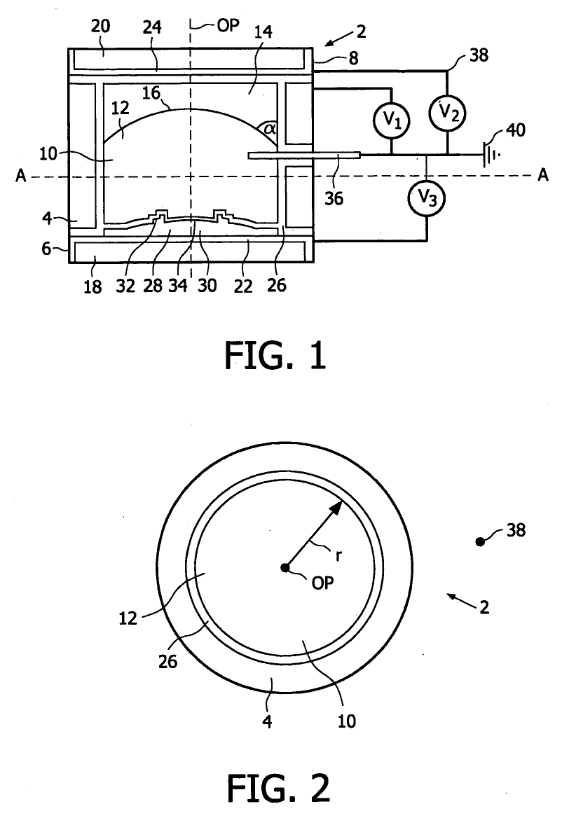

FIG. 1 shows schematically a cross section of a switchable optical element 2 in accordance with a first embodiment of the present invention. FIG. 2 shows schematically a cross section of the element 2 taken along the line A-A indicated in FIG. 1. The element 2 comprises a cylindrical electrode 4 having a longitudinal axis, which is coincident with an optical path OP of the element 2. A first end of the cylindrical electrode 4 is covered by a first wall 6 and a second end of the cylindrical electrode 4 is covered by a second wall 8. The first wall 6, the second wall 8 and the cylindrical electrode 4 define a cylindrical chamber 10 which encloses a first fluid 12 and a second, different, fluid 14 which are immiscible with each other. A fluid meniscus 16 separates the first fluid 12 from the second fluid 14 and is located at least partly on the optical path OP. In this embodiment the meniscus 16 is centred about the optical path OP. The chamber 10 has a radius r taken perpendicular from the optical path OP.

In this embodiment the first fluid 12 is an electrically conductive liquid with a first refractive index, for instance a solution of potassium chloride (KCI) in water having a concentration of 0.1M and a refractive index of 1.34, and the second fluid 14 is an electrically insulative liquid with a second refractive index, for instance a copolymer of polyphenylmethylsiloxane and polydimethylsiloxane having a refractive index of 1.50. It is envisaged that the second fluid may alternatively be electrically conductive, but have a lower electrical conductivity than the first fluid 12.

The first wall 6 comprises a first plate 18 and the second wall 8 comprises a second plate 20. Each of the first and second plates 18, 20 are circular, planar, centred about the optical path OP, and formed of a transparent material which, in this example, is glass. A first switching electrode 22 lies in contact with both a surface of the first plate 18, which faces towards the chamber 10, and a peripheral surface of the first plate 18. The first switching electrode 22 is circular, has a U-shaped cross section, is centred about the optical path OP and is formed of a transparent and electrically conductive material which, in this example, is indium tin oxide (ITO). A second switching electrode 24 lies in contact with both a surface of the second plate 20 which faces towards the chamber 10 and with a peripheral surface of the second plate 20. The second switching electrode 24 is circular, has a U-shaped cross section, is centred about the optical path OP and is formed of a transparent and electrically conductive material which, in this example, is indium tin oxide (ITO). A hydrophobic layer 26 which is electrically insulative and transparent, coats a surface of the second switching electrode 24 which faces towards the chamber 10. The hydrophobic layer 26 also coats an inner surface of the cylindrical electrode 4 and separates and insulates the first and the second switching electrodes 22, 24 from end surfaces of the cylindrical electrode 4. In this example the hydrophobic layer 26 is formed of Teflon™ AF 1600 produced by Dupont™.

A part of the first wall 6 and a part of the second wall 8 are transparent and are spaced from each other along the optical path OP. The first wall part and the second wall part each have a radius, in a direction perpendicular the optical path OP, which is the same as the radius r of the chamber 10. The first wall part and the second wall part each have a thickness, in a direction parallel the optical path OP, which is the same as a thickness, taken in the same direction, of the first wall 6 and the second wall 8, respectively.

The first wall part includes a non-planar wavefront modifier 28, which includes at least one of an aspherical lens; a phase structure having a periodic profile; and a phase structure having a non-periodic profile. In this embodiment the non-planar wavefront modifier 28 is an aspherical lens 30, which includes a non-periodic phase structure (NPS) 32. The NPS 32 is an annular phase structure comprising a plurality of annular protrusions, which have a non-periodic profile. The NPS 32 is formed within a surface of the aspherical lens 30. A surface of the aspherical lens 30 and a surface of the NPS 32 constitute a wavefront modifier surface 34 of the first wall part which is coated with the hydrophobic layer 26. The wavefront modifier 28 is mounted on a portion of the first switching electrode and is centred about the optical path OP such that the aspherical lens 30, which is circular, and the NPS 32, are centred about the optical path OP. The wavefront modifier 28 is constructed in accordance with specific dimensions such that a desired wavefront modification can be introduced by the wavefront modifier 28 into a radiation beam passing along the optical path OP. The dimensions of the wavefront modifier 28, as illustrated in FIG. 1, are not shown according to scale and are not intended to indicate the specific dimensions of the wavefront modifier 28. In this embodiment the wavefront modifier 28 is formed of a material, which has approximately the same refractive index as the second refractive index, for example hexanediol diacrylate (HDDA) which has a refractive index, for a radiation beam having a predetermined wavelength of 408 nm, of 1.51.

The element 2 comprises a ground electrode 36 which is inserted through an opening in the cylindrical electrode 4 and which lies in contact with the first fluid 12. The ground electrode 36 is electrically connected to a ground terminal 40. The hydrophobic layer 26 coats an inner surface of the opening in the cylindrical electrode 4 in order to insulate the ground electrode 36 from the cylindrical electrode 4.

The fluid meniscus 16 is capable of being arranged to focus a radiation beam travelling along the optical path OP. The fluid meniscus 16 has a curvature, which determines an amount of this focus. The curvature is rotationally symmetric about the optical path OP and is shown in FIG. 1 as having a convex curvature when viewed from the second wall 8. The element 2 comprises a variable focus system (not indicated) which is capable of varying the curvature by applying electrowetting forces to the first and the second fluids 12, 14. The variable focus system comprises a first voltage source V₁ which is electrically connected to the cylindrical electrode 4 and to the ground terminal 40. Application of a voltage by the first voltage source V₁ to the cylindrical electrode 4 determines an extent of a contact angle α between the fluid meniscus 16 and a portion of the hydrophobic layer 26 which covers the inner surface of the cylindrical electrode 4. The extent of the contact angle α determines the curvature of the meniscus 16. Variation of the voltage applied by the first voltage source V₁ varies the extent of the contact angle α and consequently varies the curvature of the meniscus 16 such that convex, concave or planar curvatures may be obtained.

The element 2 comprises a fluid switching system (not indicated), which is arranged to apply electrowetting forces to the first and/or the second fluids 12, 14 in order to switch the element 2 between a first state and a second state. The first state and the second state will be described later in further detail. The fluid switching system comprises the first switching electrode 22, the second switching electrode 24, a second voltage source V₂ and a third voltage source V₃. The fluid switching system comprises an electrical connection system 38 which electrically connects the second voltage source V₂ to the second switching electrode 24 and to the ground terminal 40, and which electrically connects the third voltage source V₃ to the first switching electrode 22 and to the ground terminal 40. FIG. 1 shows the element 2 in the first state where the first wall part, including the wavefront modifier 28, is covered by the first fluid 12 and the second wall part is covered by the second fluid 14. The fluid switching system applies electrowetting forces to the first and second fluids 12, 14 by application of an appropriate voltage from the third voltage source V₃ to the first switching electrode 22. In this first state, the second voltage source V₂ does not apply a voltage to the second switching electrode 24.

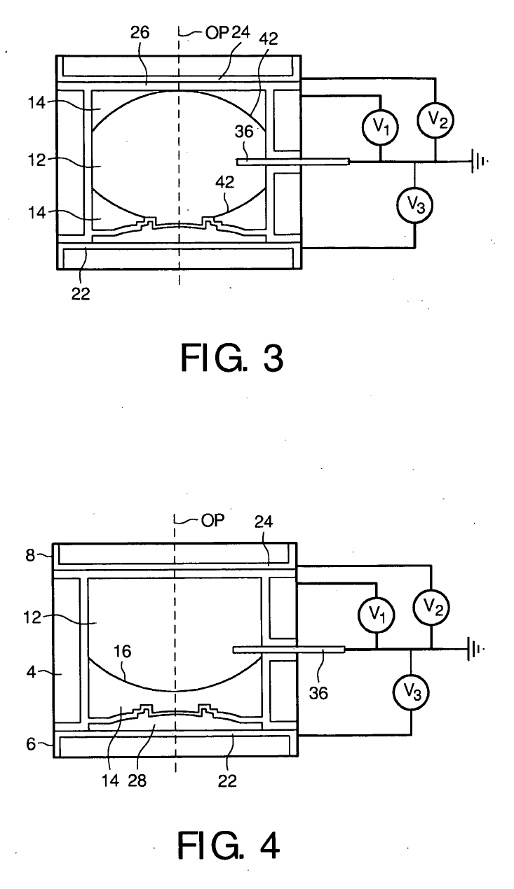

FIG. 3 shows the element 2 in an intermediate state, which occurs during switching the element 2 between the first state and the second state. In this state, the second voltage source V₂ does not apply a voltage to the second switching electrode 24, the third voltage source V₃ does not apply a voltage to the first switching electrode 22 and the first voltage source V₁ does not apply a voltage to the cylindrical electrode 4. The first fluid 12 has a configuration, which minimises contact of the first fluid 12 with the hydrophobic layer 26. At least one further fluid meniscus 42, which is different to the fluid meniscus 16 described previously, maintains the separation of the first and the second fluids 12, 14 when the element 2 is in the intermediate state. In further embodiments of the present invention, when the element 2 is in the intermediate state, a voltage may also be applied by the second voltage source V₂ to the second switching electrode 24 in order to accelerate switching of the element from the first state to the second state. Similarly, when switching to the first state from the second state, the third voltage source V₃ may apply a voltage to the first switching electrode 22 when the element is in the intermediate state.

FIG. 4 shows the element 2 in the second state where the first wall part, including the wavefront modifier 28, is covered by the second fluid 14 and the second wall part is covered by the first fluid 12. The fluid switching system applies electrowetting forces to the first and second fluids 12, 14 by application of an appropriate voltage from the second voltage source V₂ to the second switching electrode 24. In this second state, the third voltage source V₃ does not apply a voltage to the first switching electrode 22. In FIG. 4 the fluid meniscus 16 is shown having a curvature, which is convex when viewed from the first wall 6. The first voltage source V₁ applies an appropriate voltage to the cylindrical electrode 4 in order to achieve this convex curvature.

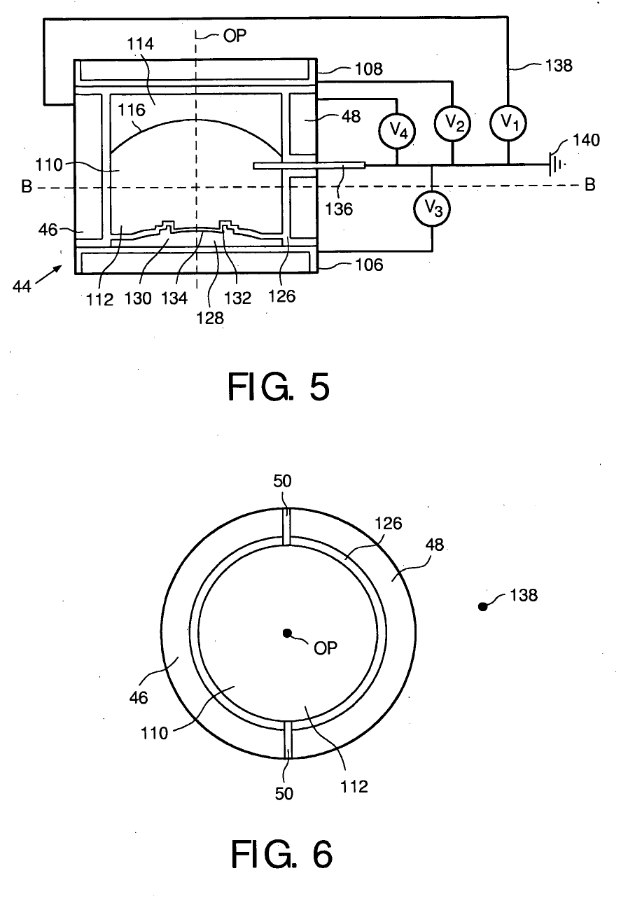

FIGS. 5, 6 and 7 show an optical switchable element 44 of the present invention in accordance with a different embodiment. Features described in accordance with this embodiment are similar to those described in accordance with the previous embodiment. Such features are referenced using the same reference numerals incremented by 100 and similar descriptions should be taken to apply here also.

FIG. 5 shows the switchable optical element 44 in the first state and FIG. 6 shows a cross-section of the element 44 taken along the line B-B indicated in FIG. 5. In this embodiment there is no cylindrical electrode, as described for the previous embodiment. The chamber 110 is defined by the first and second walls 106, 108, a semi-cylindrical electrode 46 and a further semi-cylindrical electrode 48. The semi-cylindrical electrodes 46, 48 are aligned relatively to each other to form a cylinder. The first wall 106 and the second wall 108 cover a first end and a second end of this cylinder, respectively. The hydrophobic layer 126 covers an inner surface of this cylinder and an insulating layer 50 is located along longitudinal edges of the semi-cylindrical electrodes 46, 48 in order to separate and insulate the two semi-cylindrical electrodes 46, 48 from each other. This insulating layer 50 is, for example, formed of parylene, polyethylene, or Teflon™ 1600 produced by DuPont™.

The semi-cylindrical electrode 46 is electrically connected to the first voltage source V₁. A fourth voltage source V₄ is electrically connected to the further semi-cylindrical electrode 48 and to the ground terminal 40. The ground electrode 136 is inserted through, and insulated from, the further semi-cylindrical electrode 48 in a similar manner to that described previously for the cylindrical electrode.

In this embodiment, with the element 44 in the first or the second state, the variable focus system determines the curvature of the fluid meniscus 116 by application of an appropriate voltage from the first voltage source V₁ to the semi-cylindrical electrode 46. The variable focus system also controls the fourth voltage source V₄ to apply a voltage, which is the same as the appropriate voltage applied by the first voltage source V₁, to the further semi-cylindrical electrode 48. In this way the curvature of the fluid meniscus 116 is determined and the curvature is rotationally symmetric about the optical path OP. In order to vary the curvature of the fluid meniscus 116, the voltage applied by the first voltage source V₁ to the semi-cylindrical electrode 46 and the voltage applied by the fourth voltage source V₄ to the further semi-cylindrical electrode 48, are varied in unison such that these two voltages remain identical to each other.

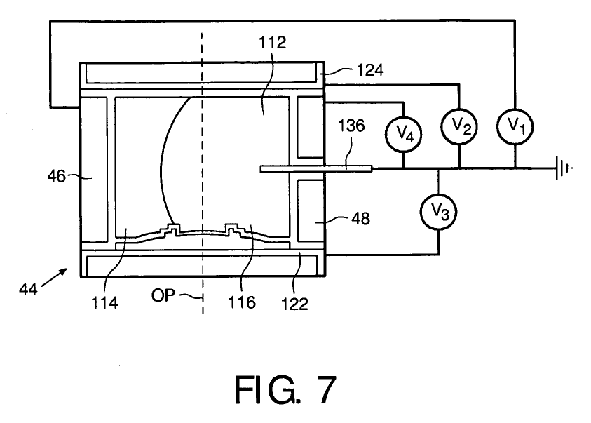

FIG. 7 shows the switchable optical element 44 in an intermediate state during switching of the element 44 between the first state and the second state. In the intermediate state the first voltage source V₁, the second voltage source V₂ and the third voltage source V₃ do not apply a voltage to the semi-cylindrical electrode 46, the first switching electrode 122 and the second switching electrode 124, respectively. The fluid switching system controls the fourth voltage source V₄ to apply an appropriate voltage to the further semi-cylindrical electrode 48. This voltage applies electrowetting forces to the first and second fluids 112, 114 such that the first fluid 112 covers a portion of the hydrophobic layer 126 lying between the chamber 110 and the further semi-cylindrical electrode 48 and such that the first fluid 112 lies in contact with the ground electrode 136. The second fluid 114 covers a portion of the hydrophobic layer 126 lying between the chamber 110 and the semi-cylindrical electrode 46. Both the first wall part and the second wall parts are partially covered by the first fluid 112 and the second fluid 114.

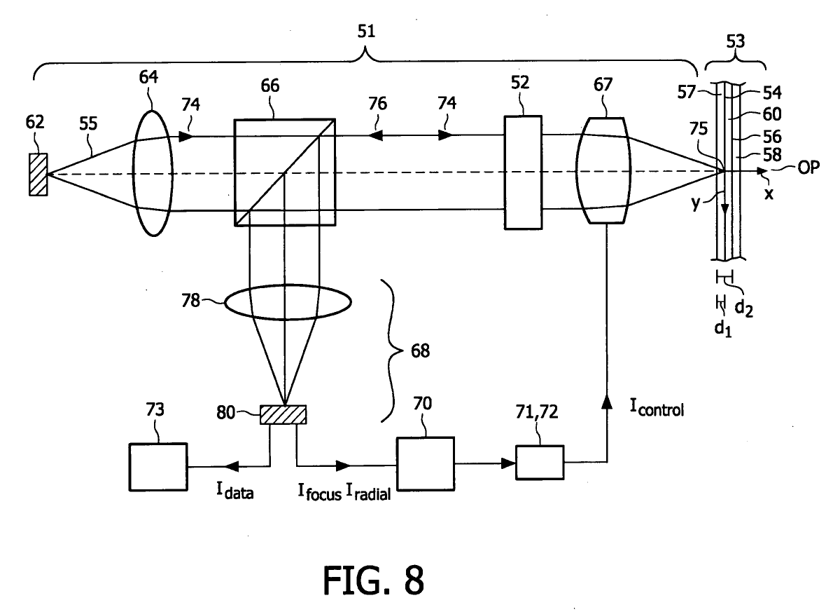

FIG. 8 shows schematically an optical scanning device 51 including a switchable optical element 52 in accordance with an embodiment of the present invention. The optical scanning device can scan a first format, a second, different, format and a third, different, format of optical record carrier with a first radiation beam having a first predetermined wavelength λ₁, a second radiation beam having a second, different, predetermined wavelength λ₂, and a third radiation beam 55 having a third, different, predetermined wavelength λ₃, respectively. The third format of optical record carrier 53 is illustrated in FIG. 8 and has a first information layer 54 and a second information layer 56 which are scanned by means of the third radiation beam 55. The third format of optical record carrier 53 includes a cover layer 57, formed for example of polycarbonate, on one side of which the first information layer 54 is arranged. The side of the second information layer 56 facing away from the cover layer 57 is protected from environmental influences by a further cover layer 58. The first information layer 54 and the second information layer 56 are separated by a separating layer 60. The cover layer 57 and/or the separating layer 60 act as a substrate for the third optical record carrier 53 by providing mechanical support for the first and second information layers 54, 56. The cover layer 57 may, alternatively, have the function of protecting the first information layer 54, while the mechanical support is provided by at least one of the separating layer 60, the second information layer 56 and the further cover layer 58. The first information layer 54 has a first information layer depth d₁ within the record carrier, which corresponds to the thickness of the cover layer 57. The second information layer 56 has a second information layer depth d₂ within the record carrier, which corresponds to the combined thickness of the cover layer 57 and the separating layer 60. The first and second formats of optical record carrier have at least one information layer lying at a different first information layer depth, which corresponds with the thickness of the cover layer of the first and second format of optical record carriers, respectively. The first information layer depth d₁ of the third format of optical record carrier 53 is less than the first information layer depth of the second optical record carrier, which is less than the first information layer depth of the first optical record carrier.

The first information layer 54 and the second information layer 56 are surfaces of the third optical record carrier 53. Similarly the first information layer of the first and second formats of optical record carrier, are surfaces. Each of these surfaces contains at least one track, i.e. a path to be followed by the spot of a focused radiation on which path optically-readable marks are arranged to represent information. The marks may be, e.g., in the form of pits or areas with a reflection coefficient or a direction of magnetisation different from the surroundings. In the case where the third format of optical record carrier 53 has the shape of a disc, the following is defined with respect to a given track: the “radial direction” is the direction of a reference axis, the X-axis, between the track and the centre of the disc and the “tangential direction” is the direction of another axis, the Y-axis, that is tangential to the track and perpendicular to the X-axis. In this embodiment the first format of optical record carrier is a compact disc (CD) and the first information layer depth is approximately 1.2 mm, the second format of optical record carrier is a conventional digital versatile disc (DVD) and the first information layer depth is approximately 0.6 mm, and the third format of optical record carrier 3 is a Blu-ray™ disc (BD) and the first information layer depth d₁ is approximately 0.075 mm. The second information layer depth d₂ of the third format of optical record carrier 53 is approximately 0.1 mm.

As shown in FIG. 8, the optical scanning device 51 has an optical path OP and includes a radiation source system 62, a collimator lens 64, a beam splitter 66, an objective lens system comprising the switchable optical element 52 and an objective lens 67, and a detection system 68. Furthermore, the optical scanning device 51 includes a servo circuit 70, a focus actuator 71, a radial actuator 72, and an information processing unit 73 for error correction.

The radiation source system 62 is arranged for consecutively or simultaneously producing the first radiation beam, the second radiation beam and/or the third, different, radiation beam 55. For example, the radiation source system 62 may comprise either a tunable semiconductor laser for consecutively supplying the radiation beams or three semiconductor lasers for simultaneously or consecutively supplying these radiation beams. In this embodiment the third wavelength λ₃ is shorter than the second wavelength λ₂. The second wavelength λ₂ is shorter than the first wavelength λ₁. In this embodiment the first, second and third wavelength λ₁, λ₂, λ₃, respectively, is within the range of approximately 770 to 810 nm for λ₁, 640 to 680 nm for λ₂, 400 to 420 nm for λ₃ and preferably approximately 785 nm, 650 nm and 405 nm, respectively. The first, second and third radiation beams have a numerical aperture (NA) of approximately 0.5, 0.65 and 0.85 respectively.

The collimator lens 64 is arranged on the optical path OP for transforming the third radiation beam 55 into a third substantially collimated beam 74. Similarly, it transforms the first and second radiation beams into a first substantially collimated beam and a second substantially collimated beam (not illustrated in FIG. 8).

The beam splitter 66 is arranged for transmitting the first, second and third collimated radiation beams toward the objective lens system. Preferably, the beam splitter 66 is formed with a plane parallel plate that is tilted with an angle β with respect to the optical path OP and, preferably, β=45°.

The objective lens system is arranged to focus the first, second and third collimated radiation beams to a desired focal point on the first, second and third optical record carriers, respectively. The desired focal point for the first, second and third radiation beams is a first, second and third scanning spot 75, respectively. Each scanning spot corresponds to a position on the first information layer of the appropriate optical record carrier or in the case of the third format 53, alternatively a position on the second information layer 56. Each scanning spot is preferably substantially diffraction limited and has a wave front aberration, which is less than 70 mλ.

The switchable optical element 52 in accordance with this embodiment may have the form of the embodiment described in relation to FIGS. 1 to 4, or the form of the embodiment described in FIGS. 5 to 7. In this embodiment the wavefront modifier 28; 128 comprises the aspherical lens 30; 130 and the NPS 32; 132. The wavefront modifier 28; 128 has specific dimensions which introduce a different predetermined wavefront modification into the first radiation beam and into the second radiation beam. The wavefront modifier 28; 128 is formed of hexanediol diacrylate (HDDA) and the part of the hydrophobic layer 26; 126 which covers the wavefront modifier surface 34; 134 has a thickness which is smaller than the first, second and third wavelength λ₁, λ₂, λ₃ so that the hydrophobic layer 26; 126 does not modify the wavefront of the first, second and third radiation beams. The first fluid 12; 112 is salted water and the second fluid 14; 114 is oil. The oil has the same, or at least approximately the same, refractive index for a radiation beam having a predetermined wavelength of 408 nm as the refractive index of the material of the wavefront modifier 28; 128. The radius r of the chamber 10; 110 is approximately 5 mm.

The objective lens 67 has a NA of approximately 0.85 and is optimised to focus a radiation beam having a predetermined wavelength of approximately 405 nm onto an information layer lying at a depth of approximately 0.1 mm within an optical record carrier.

During scanning, and with the switchable optical element 52 in the second state, the third optical record carrier 53 rotates on a spindle (not illustrated in FIG. 8) and the first information layer 54 is then scanned through the cover layer 57. The focused third radiation beam 74 reflects on the first information layer 54, thereby forming a reflected third radiation beam which returns on the optical path OP of the forward converging focused third radiation beam provided by the objective lens system. The objective lens system transforms the reflected third radiation beam to a reflected collimated third radiation beam 76. The beam splitter 66 separates the forward third radiation beam 74 from the reflected third radiation beam by transmitting at least a part of the reflected third radiation beam 76 towards the detection system 68.

The detection system 68 includes a convergent lens 78 and a quadrant detector 80 which are arranged for capturing said part of the reflected third radiation beam 76 and converting it to one or more electrical signals. One of the signals is an information signal I_{data}, the value of which represents the information scanned on the information layer 54. The information signal I_{data} is processed by the information processing unit 73 for error correction. Other signals from the detection system 68 are a focus error signal I_{focus} and a radial tracking error signal I_{radial}. The signal I_{focus} represents the axial difference in height along the optical path OP between the third scanning spot 75 and the position of the first information layer 54. Preferably, this signal is formed by the “astigmatic method” which is known from, inter alia, the book by G. Bouwhuis, J. Braat, A. Huijser et al, entitled “Principles of Optical Disc Systems,” pp. 75-80 (Adam Hilger 1985) (ISBN 0-85274-785-3). A device for creating an astigmatism according to this focusing method is not illustrated. The radial tracking error signal I_{radial} represents the distance in the XY-plane of the first information layer 54 between the first scanning spot 75 and the center of a track in the information layer 54 to be followed by the first scanning spot 75. Preferably, this signal is formed from the “radial push-pull method” which is known from, inter alia, the book by G. Bouwhuis, pp. 70-73.

The servo circuit 70 is arranged for, in response to the signals I_{focus} and I_{radial}, providing servo control signals I_{control} for controlling the focus actuator 71 and the radial actuator 72, respectively. The focus actuator 71 controls the position of a lens of the objective lens system along the optical path OP, thereby controlling the position of the scanning spot 75 such that it coincides substantially with the plane of the first information layer 54. The radial actuator 72 controls the position of the objective lens 67 of the objective lens system along the X-axis, thereby controlling the radial position of the scanning spot 75 such that it coincides substantially with the centre line of the track to be followed in the first information layer 54.

When scanning the first information layer 54 of the third format of optical record carrier 53, the switchable optical element 52 is in the second state and the variable focus system controls the fluid meniscus 216 so that the curvature is convex when viewed from the second wall 208 and has a curvature of approximately 0.02 mm⁻¹. The variable focus system can vary the curvature of the fluid meniscus 16; 116 to a planar curvature of 0.00 mm⁻¹ in order to move the scanning spot 75 of the third radiation beam 74 from the first information layer 54 onto the second information layer 56.

When scanning the first format of record carrier and the second format of record carrier using the first and second radiation beam, respectively, the switchable optical element 52 is switched into the first state and the variable focus system controls the fluid meniscus 16; 116 so that the curvature is planar.

When scanning the first information layer of any of the formats of optical record carrier the cover layer introduces an amount of spherical aberration into the radiation beam scanning the optical record carrier. When scanning the second information layer 56 of the third format of record carrier 53, the cover layer 57 and the separating layer 60 introduce an amount of spherical aberration into the third radiation beam 74.

When scanning the first information layer of one of the formats of optical record carrier, the objective lens system introduces an amount of spherical aberration, into the radiation beam, which has an opposite sign and which is of approximately the same amount as the amount of spherical aberration introduced by the cover layer. When scanning the second information layer 56 of the third format of optical record carrier 53 the objective lens system introduces an amount of spherical aberration, into the third radiation beam 74, which has an opposite sign and which is of approximately the same amount as the amount of spherical aberration introduced by the cover layer 57 and the separating layer 60. Switching the switchable optical element 52 into the appropriate state and varying the curvature of the fluid meniscus 16; 116 determines the amount of spherical aberration introduced by the objective lens system and ensures that the radiation beam is focused accurately to the scanning spot. When scanning the first, second and third formats of optical record carrier, a root mean square (RMS) wavefront aberration of the scanning spot is approximately 13 mλ, 9 mλ and 15 mλ, respectively.

The above embodiments are to be understood as illustrative examples of the invention. Further embodiments of the invention are envisaged. For example, in further embodiments where it is desired for the switchable optical element to introduce a different wavefront modification into a radiation beam of a same or a different predetermined wavelength to those described previously, the refractive index of the first and second fluids, the refractive index of the material of the wavefront modifier, the structure of the non-planar wavefront modifier, materials of the switchable optical element, a volume of the first and the second fluids and dimensions of the switchable optical element such as the radius of the chamber or a thickness or configuration of the first and/or the second wall parts, may be different to those described above.

In the embodiments of the present invention described, the second fluid has a refractive index, which is the same as the refractive index of the material of the wavefront modifier. In further embodiments the material of the wavefront modifier may alternatively have a refractive index which is different to the refractive index of the first and the second fluid. It is further envisaged that at least one of the fluids may be a gas, instead of being a liquid.

In further embodiments, in addition to the first wall part including a wavefront modifier, the second wall part may also include a non-planar wavefront modifier, which includes, for example, at least one of an aspherical lens, a non-periodic phase structure and a periodic phase structure.

In further embodiments the electrodes for switching the state of the element and/or for varying the curvature of the fluid meniscus, may be arranged according to a different configuration, or may have different shapes. For example, the first switching electrode may alternatively be arranged across the surface of the wavefront modifier. In further embodiments the switchable optical element may have a configuration of electrodes without the ground electrode. In such embodiments a voltage is applied to at least two of the electrodes of the element in order to position the first and second fluids as desired. For example, for the element described previously with reference to FIGS. 5 to 7, but without the ground electrode, the element may be switched from the first state, where a voltage is applied to the first switching electrode and to each of the semi-cylindrical electrodes, to the second state, where a voltage is applied to the second switching electrode and to both of the semi-cylindrical electrodes, by applying a voltage to both the first switching electrode and the further semi-cylindrical electrode and then by applying a voltage to both the second switching electrode and the further semi-cylindrical electrode. In this way the first fluid and second fluid are moved within the chamber. The magnitude of the applied voltages is relatively higher than that of the applied voltages described for previous embodiments and the first fluid adopts a voltage with a magnitude less than that of the applied voltages, for example, approximately half the magnitude.

It is further envisaged that the fluid switching system and/or the variable focus system may apply different types of forces, which are not electrowetting forces, to the fluids in order to switch the state of the element and to vary the curvature of the fluid meniscus, respectively. In different embodiments where a variable focus of a radiation beam is not desired, the switchable optical element does not include the variable focus system described. In such embodiments, the element may be arranged to provide a fixed focus to a radiation beam.

In previously described embodiments it has been described that convex, concave and planar curvatures of the fluid meniscus are obtainable, all of which are rotationally symmetric about the optical path OP. In further embodiments, curvatures of the fluid meniscus may be achieved which are not rotationally symmetric about the optical path OP.

In further embodiments of the present invention, the element may have a conduit which is fluidly connected to the chamber, or the element may comprise two concentric cylinders, which facilitate movement of the first and the second fluids within the element during switching of the state of the element.

The switchable optical element is described as being included within an optical scanning device for scanning three formats of optical record carrier, one format having two information layers. In further embodiments the switchable optical element may be adapted such that, when included within an optical scanning device and by switching the states of the switchable optical element, the optical scanning device can scan different formats of optical record carrier, which may include CD, DVD or Blu-Ray™ and which may have one or a plurality of information layers. By varying the curvature of the fluid meniscus, it is envisaged that different information layers can be scanned of a record carrier having a plurality of information layers.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A switchable optical element having an optical path (OP) for a radiation beam and having a first state and a second state, said element comprising:
a) a first fluid (12; 112) and a second, different, fluid (14; 114) which are immiscible and which are separated from each other by a fluid meniscus (16; 116);
b) a first, transparent, wall part and a second, transparent, wall part spaced from each other along the optical path; and
c) a fluid switching system which is arranged to apply forces to said first and/or said second fluid in order to switch said element between said first and said second state,
wherein the first wall part includes a non-planar wavefront modifier (28; 128), and wherein the fluid switching system is arranged to apply said forces so that:
when the element is in the first state, said first wall part is covered by the first fluid (12; 112); and
when the element is in the second state, said first wall part is covered by the second fluid (14; 114),
characterised in that the fluid switching system is arranged to switch between said first state and said second state such that when the element is in the first state said second wall part is covered by the second fluid, and when the element is in the second state said second wall part is covered by the first fluid, wherein when the element is in both the first state and the second state at least part of said fluid meniscus (16; 116) is located on the optical path.

2. A switchable optical element according to claim 1, wherein said first fluid is a liquid which is electrically conductive and said second fluid is a liquid which is either electrically insulative or which has a lower electrical conductivity than said first fluid.

3. A switchable optical element according to claim 1, wherein when the element is in at least one of the first and the second state, said fluid meniscus is capable of being arranged to focus a radiation beam travelling along the optical path.

4. A switchable optical element according to claim 3, wherein when said element is in at least one of the first and the second state, said fluid meniscus has a curvature which determines an amount of said focus and said element comprises a variable focus system capable of varying the curvature of the fluid meniscus.

5. A switchable optical element according to claim 4, wherein said variable focus system is arranged to vary said curvature using electrowetting forces.

6. A switchable optical element according to claim 1, wherein said fluid switching system includes a first and a second switching electrode (22, 24; 122, 124), wherein
said fluid switching system is arranged to apply a voltage to said first switching electrode in order to switch said element to said first state, and wherein
said fluid switching system is arranged to apply a voltage to said second switching electrode in order to switch said element to said second state.

7. A switchable optical element according to claim 4, wherein said optical element includes a further electrode (48), wherein
when switching between the first state and the second state, said fluid switching system is arranged to apply a voltage to said further electrode, and wherein
when varying the curvature of the fluid meniscus, said variable focus system is arranged to apply a voltage to said further electrode.

8. A switchable optical element according to claim 1, wherein said forces applied to the first and/or the second fluid by the fluid switching system are electrowetting forces.

9. A switchable optical element according to claim 1, wherein said non-planar wavefront modifier includes at least one of: an aspherical lens (30); a phase structure having a periodic profile; and a phase structure having a non-periodic profile (32).

10. A switchable optical element according to claim 1, wherein said first fluid has a first refractive index and said second fluid has a second, different, refractive index, wherein said non-planar wavefront modifier is formed of a material having a refractive index which is approximately the same as said second refractive index.

11. An optical scanning device for scanning a record carrier (53) having an information layer (54, 56), wherein said optical scanning device comprises:
a) a switchable optical element (52) in accordance with claim 1;
b) a radiation beam source system (62) arranged to provide a radiation beam (55) having a predetermined wavelength;
c) an objective lens system arranged to focus said provided radiation beam to a scanning spot (75) on said information layer; and
d) a detection system (68) arranged to detect the radiation beam after scanning of the information layer and to convert radiation of the detected radiation beam into electrical signals.

12. An optical scanning device according to claim 11, wherein the record carrier has a plurality of information layers (54, 56) lying at different depths (d₁, d₂) within the record carrier, wherein said variable focus system is arranged to vary the curvature of the fluid meniscus in order to move the scanning spot on one of said plurality of information layers to a different one of said plurality of information layers.

13. An optical scanning device according to claim 11, wherein said radiation beam source system is arranged to provide a first radiation beam of a first predetermined wavelength, a second radiation beam of a second, different, predetermined wavelength and a third radiation beam of a third, different, predetermined wavelength, wherein:
when said switchable optical element is in said first state, the optical scanning device is arranged to scan a record carrier of a first format with said first radiation beam and to scan a record carrier of a second, different, format with said second radiation beam; and
when said switchable optical element is in said second state, the optical scanning device is arranged to scan a record carrier of a third, different, format with said third radiation beam.
